(19) United States
(12) Patent Application Publication
(10) Pub. No.: US 2017/0230589 A1
(43) Pub. Date: Aug. 10, 2017

(54) TARGETING CAMPAIGN IN AUGMENTED REALITY

(71) Applicant: AURASMA LIMITED, Bracknell, Berkshire (GB)

(72) Inventors: Robert Paul Severn, San Francisco, CA (US); David Stone, Alameda, CA (US); Waleed Hamied, Alpharetta, GA (US)

(73) Assignee: Aurasma Limited, Bracknell, Berkshire (GB)

(21) Appl. No.: 15/515,257

(22) PCT Filed: Sep. 29, 2014
(86) PCT No.: PCT/US2014/057952

§ 371 Date: Mar. 29, 2017

(51) Int. Cl. H04N 5/272; H04N 21/2668; H04N 21/4725; G06Q 30/02; H04L 29/06

(52) U.S. Cl. CPC H04N 5/2723; G06Q 30/0222; H04L 65/604; H04N 21/4725; H04N 21/2668; H04L 65/4084; H04N 21/236

(57) ABSTRACT

Examples of techniques for targeting campaigns in augmented reality are disclosed, In one example implementation according to aspects of the present disclosure a plurality of augmented reality overlays to be is based on a received trigger image are generated A plurality of targeting groups are then defined. For example, a targeting group may be associated with a targeting campaign aimed at a classification of user, which may be a subset of the plurality of augmented reality overlays.

### BACKGROUND

Augmented reality platforms provide the ability to overlay digital media content (e.g., images, videos, three-dimensional models, etc.) onto a trigger image. The trigger image represents an image or other graphical representation that, when scanned by an augmented reality enabled device (e.g., a mobile phone, smart phone, tablet computing device, etc.) using image recognition, activates digital media content to be displayed on the augmented reality enabled device. A variety of digital media content may be displayed concurrently, in succession, or in similar combinations on the augmented reality enabled device.

### BRIEF DESCRIPTION OF THE DRAWINGS

The following detailed description references the drawings, which:

FIG. 1 illustrates a block diagram of a computing system to generate targeting campaigns in augmented reality experiences according to examples of the present disclosure;

FIG. 2 illustrates a block diagram of a computing system to generate targeting campaigns in augmented reality experiences according to examples of the present disclosure;

FIG. 3 illustrates a block diagram of a computer-readable storage medium to generate targeting campaigns in augmented reality experiences according to examples of the present disclosure;

FIG. 4 illustrates a flow diagram of a method to generate targeting campaigns in augmented reality experiences according to examples of the present disclosure;

FIG. 5 illustrates a flow diagram of a method to generate targeting campaigns in augmented reality experiences according to examples of the present disclosure; and

FIG. 6 illustrates a block diagram of an augmented reality experience having targeting campaigns according to examples of the present disclosure.

### DETAILED DESCRIPTION

Augmented reality (AR) platforms may be used in sales, marketing, advertising, and other similar situations. For example, an automobile manufacture may utilize augmented reality platforms by enabling a customer or potential customer to scan a trigger image, such as the car manufacturer's logo, to learn more about the manufacturer and/or a particular automobile. If a user scans the trigger image, the user may then be provided with an augmented reality experience of watching a video about the manufacturer's newest car. The augmented reality experience may also provide additional information, such as product specifications, and/or options to the user, such as a social media link or links to share the video.

Augmented reality experiences may be tailored for specific groups (known as “targeting groups”). For example, different AR experiences may be used depending on a variety of factors such as location, age, sex, preferences, etc. In one such example, a targeting group may target males 18-29 years of age, while another targeting group may target females 13-17. These targeting groups are useful to advertisers and marketers, for example, so that content can be delivered with the targeting group individuals in mind.

Designers of augmented reality platforms rely on testing the augmented reality experiences during the design process (for example, when initially designing the AR experience or when incorporating changes to the AR experience). However, quickly testing changes to an AR experience that a designer is actively testing is difficult when incorporating changes to the AR experience for different targeting groups, This is because each experience is launched by the same trigger image.

Various implementations are described below by referring to several examples of techniques for targeting campaigns in augmented reality are disclosed. In one example implementation according to aspects of the present disclosure, a plurality of a en ted reality overlays to be displayed based on a received trigger image are generated. A plurality of targeting groups are then defined. For example, a targeting group may be associated with a targeting campaign aimed at a classification of user, which may be a subset of the plurality of augmented reality overlays.

In some implementations, the techniques for targeting campaigns in augmented reality provide a simple and efficient interface by which an augmented reality content creator can switch between targeting campaigns. This enables the content creator to view and test various targeting campaigns and their associated overlays as if the content creator were viewing the augmented reality experience as an end user. Consequently, the content creator can alter the augmented reality experience based on the viewed targeting campaigns. These and other advantages will be apparent from the description that follows.

FIGS. 1-3 include particular components, modules, instructions etc. according to various examples as described herein. In different implementations, more, fewer, and/or other components, modules, instructions, arrangements of components/modules/instructions, etc. may be used according to the teachings described herein. In addition, various components, modules, etc. described herein may be implemented as instructions stored on a computer-readable storage medium, hardware modules, special-purpose hardware (e.g., application specific hardware, application specific integrated circuits (ASICs), embedded controllers, hardwired circuitry, etc.), or some combination or combinations of these.

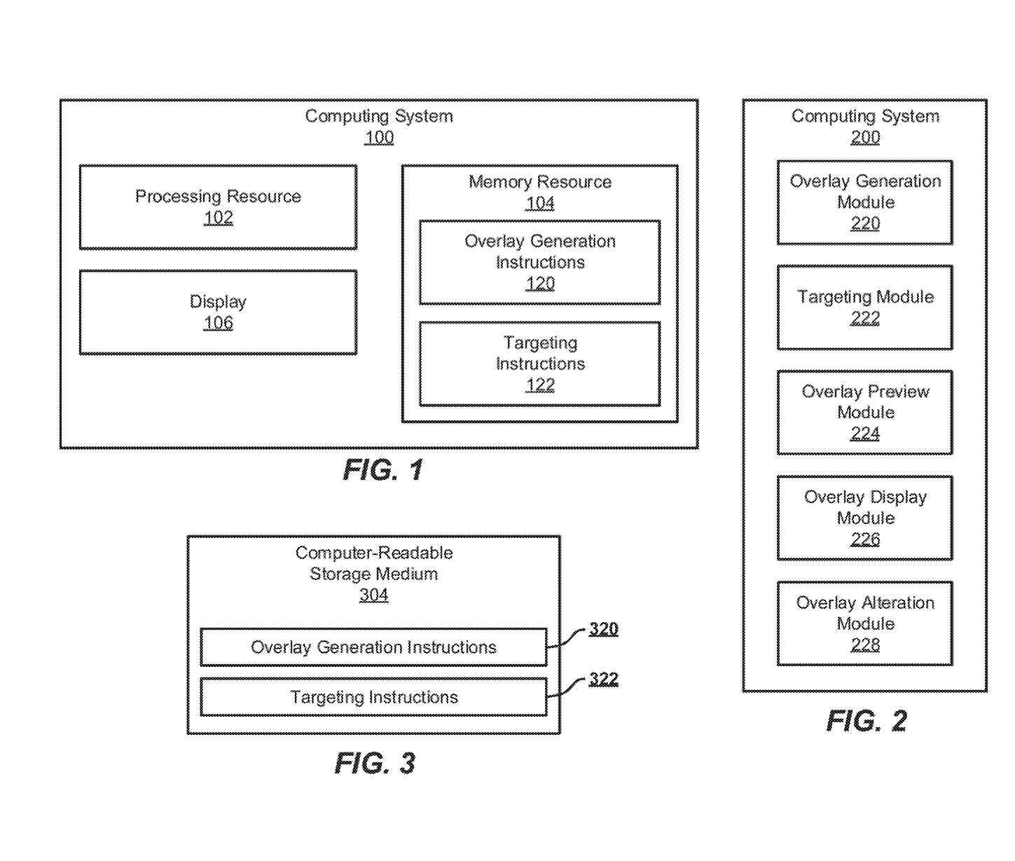

Generally, FIGS. 1-3 relate to components and modules of a computing system, such as computing system 100 of FIG. 1 and computing system 200 of FIG. 2. It should be understood that the computing systems 100 and 200 may include any appropriate type of computing system and/or computing device, including for example smartphones, tablets, desktops, laptops, workstations, servers, smart monitors, smart televisions, digital signage, scientific instruments, retail point of sale devices, video walls, imaging devices, peripherals, networking equipment, or the like.

FIG. 1 illustrates a block diagram of a computing system 100 to generate targeting campaigns in augmented reality experiences according to examples of the present disclosure. The computing system 100 may include a processing resource 102 that represents generally any suitable type or form of processing unit or units capable of processing data or interpreting and executing instructions. The processing resource 102 may be one or more central processing units (CPUs), microprocessors, and/or other hardware devices suitable for retrieval and execution of instructions. The instructions may be stored, for example, on a non-transitory tangible computer-readable storage medium, such as memory resource 104 (as well computer-readable storage medium 304 of FIG. 3), which may include any electronic, magnetic, optical, or other physical storage device that store executable instructions. Thus, the memory resource 104 may be, for example, random access memory (RAM), electrically-erasable programmable read-only memory (EPPROM), a storage drive, an optical disk, and any other suitable type of volatile or non-volatile memory that stores instructions to cause a programmable processor to perform the techniques described herein. In examples, memory resource 104 includes a main memory, such as a RAM in which the instructions may be stored during runtime, and a secondary memory, such as a nonvolatile memory in which a copy of the instructions is stored.

Alternatively or additionally, the computing system 100 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein. In some implementations, multiple processing resources (or processing resources utilizing multiple processing cores) may be used, as appropriate, along with multiple memory resources and/or types of memory resources.

In addition, the computing system 100 may include a display 106. In examples, the display 106 may be or include a monitor, a touchscreen, a projection device, and/or a touch/sensory display device. The display 106 may display text, images, and other appropriate graphical content such an augmented reality experiences, augmented reality overlays, and the like.

In this example, it should be appreciated that the computing system 100 enables a content creator to create and adapt an augmented reality experience, which may be consumed by users of user computing devices (i.e., computing systems and/or computing devices other than computing system 100).

To facilitate the creation and adaptation of an AR experience and its associated overlays and targeting groups, the computing system 100 may include overlay generation instructions 120 and targeting instructions 122. The instructions 120, 122 may be processor executable instructions stored on a tangible memory resource such as memory resource 104, and the hardware may include processing resource 102 for executing those instructions. Thus memory resource 104 can be said to store program instructions that when executed by the processing resource 102 implement the modules described herein. Other instructions may also be utilized as will be discussed further below in other examples.

The overlay generation instructions 120 generate augmented reality overlays into an aura that are to be displayed on a user computing device based on a received trigger image. The trigger image may be scanned or otherwise optically captured by the user computing device and sent to the computing system 100. The trigger image is used to initiate the AR experience. An aura is made up of a trigger image and multiple overlays. A group or collection of auras is known as a campaign, and a targeted campaign may contain targeted versions of the auras. For example, a targeted campaign is associated with a targeting group (i.e., male 20-30) such that users of the targeting group are presented with the auras within the targeted campaign.

A new overlay may be presented by the overlay generation instructions 120, which may be blank or based on a template overlay. An augmented reality experience content creator may add content to the overlay, such as text, graphics, audio, video, animation, etc. The content creator may also add links to other overlays, webpages, applications, etc.

Once the overlays are generated, the targeting instructions 122 define a plurality of targeting groups, which are aimed at a classification of user (e.g., gender, age, geographic location, etc.). Each of the targeting groups may be associated with a targeting campaign that includes a subset of the plurality of AR overlays. The targeting group is, for example, a classification of user indicated by a user property, such as a geographic location, age or age range, gender, or other user property. The user property may also be a user-defined preference.

In an example, a targeting group may be “males.” The targeting campaign, such as for an automobile manufacturer, may include augmented reality overlays targeted to males. For example, the males AR overlays may include information about sports cars and trucks. Similarly, a targeting group may be “females.” The automobile manufacture may include information on the female AR overlays about SUVs and sedans.

In another example, a targeting group may be based on demographic information, such as an age range (e.g., “25-39,” “18-21,” etc.). The campaign may be directed to people in that age range. Other examples of targeting groups is possible. Moreover, targeting groups may be combinations of user properties. For example, the auto manufacture of the previous example may desire to create campaigns directed towards “males, ages 21-30” or “females, ages 30-40.” In this way, targeting groups may be used to deliver specific content, via AR overlays, to targeted groups.

In other examples, additional instructions may be included on the memory resource 104. For example, the computing system 100 may include instructions to cause one of the campaigns to be displayed on a user computing device based on a received user property, which is indicative of the targeting group of one of the campaigns. Moreover, the computing system 100 may include instructions to preview one of the campaigns on the display 105 when one of the targeting groups is selected. That is, while developing the AR experience, a content creator may preview a campaign by selecting a targeting group. This enables the content creator to experience the campaign as a member of the targeting group and view the same AR overlays that are presented to a member of the targeting group.

FIG. 2 illustrates a block diagram of a computing system 200 to generate targeting campaigns in augmented reality experiences according to examples of the present disclosure. The computing system 200 may include an overlay generation module 220, a targeting module 222, an overlay preview module 224, an overlay display module 226, and an overlay alteration module 228.

In examples, the modules described herein may be a combination of hardware and programming instructions. The programming instructions may be processor executable instructions stored on a tangible memory resource such as a memory resource, and the hardware may include a processing resource for executing those instructions, Thus the memory resource can be said to store program instructions that when executed by the processing resource implement the modules described herein. Other modules may also be utilized as will be discussed further below in other examples. In different implementations, more, fewer, and/or other components, modules, instructions, and arrangements thereof may be used according to the teachings described herein. In addition, various components, modules, etc. described herein may be implemented as computer-executable instructions, hardware modules, special-purpose hardware (e.g., application specific hardware, application specific integrated circuits (ASICs), and the like, or some combination or combinations of these.

The overlay generation module 220 enables generating (i.e., creating) overlays by adding content to the overlays. For example, a new overlay may be presented, which may be blank or based on a template overlay. An augmented reality experience content creator may add content to the overlay, such as text, graphics, audio, video, animation, etc. The content creator may also add links to other overlays, webpages, applications, etc.

The targeting module 222 defines a plurality of targeting groups. Each of the targeting groups may be associated with a targeting campaign that includes a subset of the plurality of AR overlays. In other words, a campaign is made up of AR overlays, and the campaign is associated with a targeting group. The targeting group is, for example, a user property, such as a geographic location, age or age range, gender, or other user property. The user property may also be a user-defined preference.

The overlay preview module 224 previews one of the campaigns on a display of the computing system 200 when one of the targeting groups is selected. That is, while developing the AR experience, a content creator may preview a campaign by selecting a targeting group. This enables the content creator to experience the campaign as a member of the targeting group and view the same AR overlays that are presented to a member of the targeting group. The content creator may select any of the targeting groups to be previewed, such as by a dropdown list, pick list, or other suitable manner. The corresponding targeting campaign is then previewed to the content creator on a display of the computing system 200.

The overlay display module 226 causes one of the campaigns to be displayed on a user computing device. When the user scans a trigger image on his computing device, the trigger image and a user property of the user computing device are sent to the computing system 200 to initiate the augmented reality experience. The user property is indicative of the targeting group of the one of the campaigns, and the corresponding campaign is caused to be displayed on the user's computing device.

The overlay alteration module 228 enables the content creator to alter the content of the overlays and the targeting groups associated with them. For example, a content creator may desire to add an event (i.e., a user action such as selecting a link, or a system action such as a video ending) to an overlay after creating the overlay, or the content creator may desire to change the content on an overlay. Such alterations may be performed using the overlay alteration module 228. It should be understood that the content of an overlay, the flow of the targeting campaign, and any events associated with an overlay may be altered by the overlay alteration module 228.

FIG. 3 illustrates a block diagram of a computer-readable storage medium 304 to generate targeting, campaigns in augmented reality experiences according to examples of the present disclosure. The computer-readable storage medium 304 is non-transitory in the sense that it does not encompass transitory signal but instead is made up of one or more memory components configured to store the instructions. The computer-readable storage medium may be representative of the memory resource 104 of FIG. 1 and may store machine executable instructions in the form of modules, which are executable on a computing system such as computing system 100 of FIG. 1 and/or computing system 200 of FIG. 2.

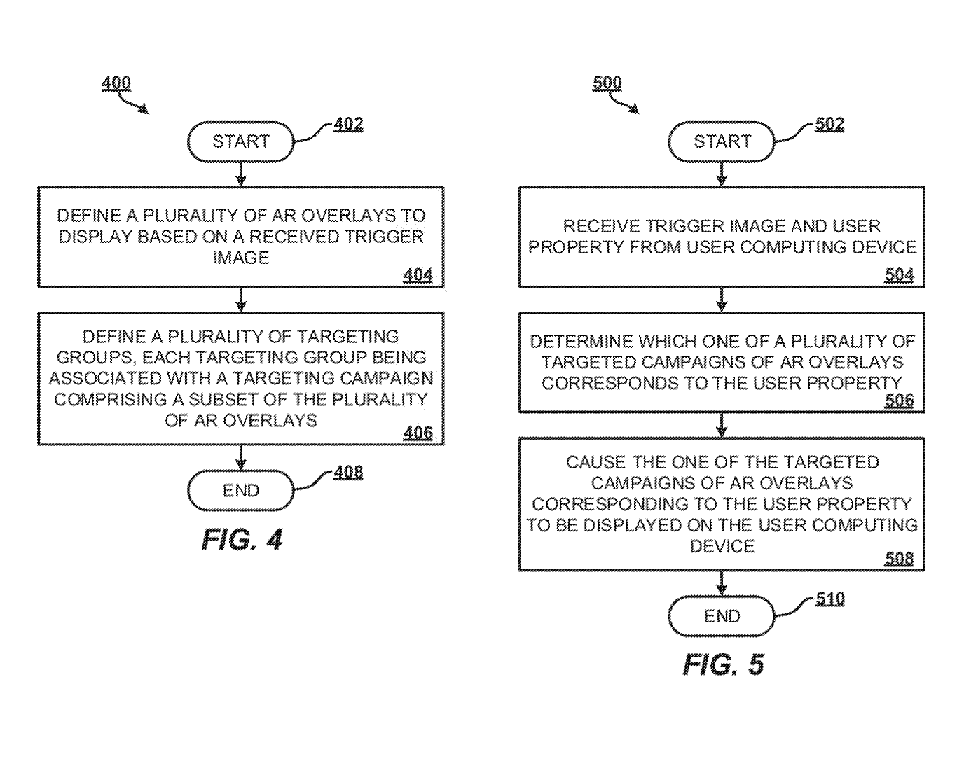

In the example shown in FIG. 3, the instructions 320, 322 may include overlay generation instructions 320 and targeting instructions 322. In other examples, additional instructions may be included in the computer-readable storage medium 304, such as overlay generation instructions and overlay alteration instructions. The instructions 320, 322 of the computer-readable storage medium 304 may be executable so as to perform the techniques described herein, including the functionality described regarding the method 400 of FIG. 4. While the functionality of these instructions 320, 322 is described below with reference to the functional blocks of FIG. 4, such description is not intended to be so limiting.

In particular, FIG. 4 illustrates a flow diagram of a method 400 to generate targeting campaigns in augmented reality experiences according to examples of the present disclosure. The method 400 may be stored as instructions on a non-transitory computer-readable storage medium such as computer-readable storage medium 304 of FIG. 3 or another suitable memory such as memory resource 104 of FIG. 1 that, when executed by a processor (e.g., processing resource 102 of FIG. 1 and/or processing resource 202 of FIG. 2), cause the processor to perform the method 400. It should be appreciated that the method 400 may be executed by a computing system or a computing device such as computing system 100 of FIG. 1 and/or computing system 200 of FIG. 2.

At block 402, the method 400 begins and continues to block 404 At block 404, the method 400 generates a plurality of augmented reality overlays to be display based on a received trigger image. The overlays contain, content to be consumed by a user viewing the augmented reality experience. Generating the AR overlays may be performed, for example, by the overlay generation instruction 120 and/or 320 of FIGS. 1 and 3 and/or by the overlay generation module 22 of FIG. 2. The method 400 continues, to block 406.

At block 406, the method 400 defines a plurality of targeting groups, each targeting group being associated with a targeting campaign aimed at a classification of user comprising a subset of the plurality of augmented reality overlays. Defining the targeting groups may be performed, for example, by the targeting instructions 122 and/or 322 of FIGS. 1 and 3 and/or by the targeting module 222 of FIG. 2.

Additional processes also may be included. For example, the method 400 may include causing one of the campaigns to be displayed on a user computing device based on a received user property of the user computing device. The received property, which may be based on geographic and/or demographic information, is indicative of the targeting group of one of the campaigns, for example. The method 400 may also include previewing one of the campaigns when one of the targeting groups is selected, such as by a content creator. The content creator may alter the campaign based on the preview, if so desired. It should be understood that the processes depicted in FIG. 4 represent illustrations, and that other processes may be added or existing processes may be removed, modified, or rearranged without departing from the scope and spirit of the present disclosure.

FIG. 5 illustrates a flow diagram of a method 500 to generate targeting campaigns in augmented reality experiences according to examples of the present disclosure. The method 500 may be executed by a computing system or a computing device such as computing system 100 of FIG. 1 and/or computing system 200 of FIG. 2. The method 500 may also be stored as instructions on a non-transitory computer-readable storage medium such as computer-readable storage medium 304 of FIG. 3 that, when executed by a processor (e.g., processing resource 102 of FIG. 1 and/or processing resource 202 of FIG. 2), cause the processor to perform the method 500.

At block 502, the method 500 begins and continues to block 504. At block 504, the method 500 includes receiving at a computing system (e.g., computing system 100 and/or 300 of FIGS. 1 and 3) a trigger image and a user property from a user computing device. The method 500 then continues to block 506, where method 500 includes determining by the computing system which one of a plurality of targeting campaigns of augmented reality overlays corresponds to the user property. The targeting module 222 of FIG. 2, for example, may receive the trigger image and user property and determine which targeting campaign corresponds to the user property.

The method 500 then continues to block 508, at which point the method 500 includes the computing system causing the one of the targeting campaigns of augmented reality overlays corresponding to the user property to be displayed on the user computing device. If it cannot be determined which targeting campaign corresponds to the user property, then a default targeting campaign may be displayed. The overlay display module 222 of FIG. 2, for examples, may cause the determined targeting campaign to be displayed. The method 500 then continues to block 510 and terminates.

Additional processes also may be included, and it should be understood that the processes depicted in FIG. 5 represent illustrations, and that other processes may be added or existing processes may be removed, modified, or rearranged without departing from the scope and spirit of the present disclosure.

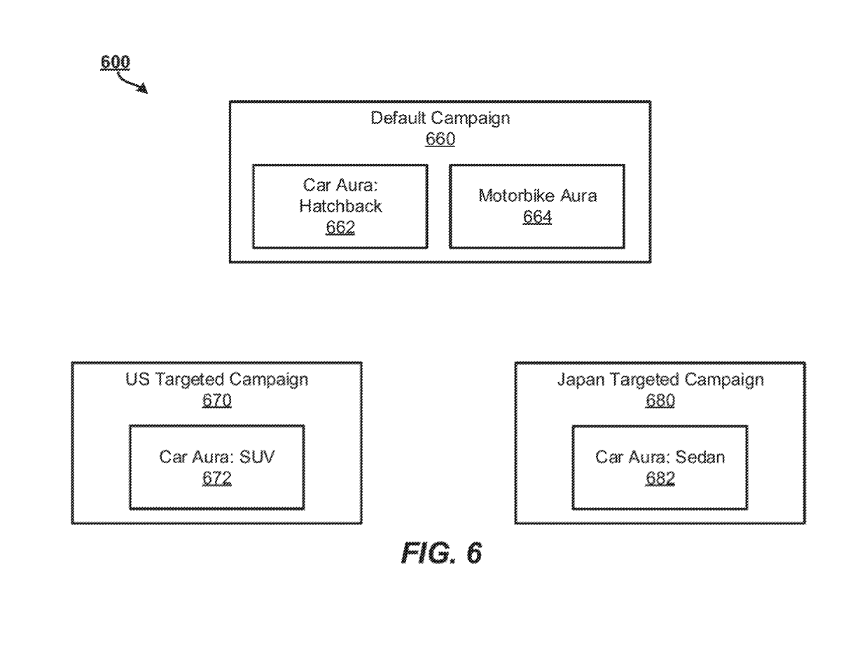

FIG. 6 illustrates a block diagram of an augmented reality experience 600 having campaigns and targeting campaigns according to examples of the present disclosure. This example relates to an augmented reality (AR) experience 600 for an automobile manufacture targeted to users in different geographic regions. The AR experience 600 includes a default campaign 660, a US targeted campaign 670, and a Japan targeted campaign 680, each with content (auras) targeted to users of a particular geographic region. Specifically, in this example, the targeting groups are based on a geographic region of a user accessing the AR experience 600. When a user scans a trigger image relating to a car with the user's computing device, a user property (in this case, the user's geographic region), may be sent to the computing system hosting the augmented reality experience, including the targeting campaign 600. The user property designates which campaign of the AR experience should be delivered to the user's device, wt the trigger image indicates which aura should be displayed for the user.

In this example, the user may be delivered one the three auras for cars depending on the user's geographic region: the car aura: hatchback 662 of default campaign 660, the car aura: SUV 672 of US targeted campaign 670, or the car aura: sedan 852 of Japan targeted campaign 680. If the user is in the US and scans a car trigger image, the user is delivered the US targeted campaign 670 and is shown the car aura: SUV 672. Similarly, if the user is in Japan and scan a car trigger image, the user is delivered the Japan targeted campaign 680 and is shown the aura SUV 672, If the user is not in a region for which a campaign is defined, or if it cannot be determined which region the user is in, and the user scans a car trigger image, the user is delivered the default campaign 660 and is shown oar aura: hatchback 662. However, if the user scans a motorbike trigger image, the user is shown the motorbike aura 664 of default campaign 660 regardless of the user's region since the motorbike aura 684 is present only in the default campaign 660 (i.e., the US targeted campaign 670 and the Japan targeted campaigns 680 do not include motorbike auras, although they could in other examples).

It should be understood that the example shown in FIG. 6 is merely one of many possible examples of targeting campaigns. Campaigns can be based on any number of suitable user preferences. Moreover, the campaigns can include a variety of different content/auras as well as multiple auras.

It should be emphasized that the above-described examples are merely possible examples of implementations and set forth for a clear understanding of the present disclosure. Many variations and modifications may be made to the above-described examples without departing substantially from the spirit and principles of the present disclosure. Further, the scope of the present disclosure is, intended to cover any and all appropriate combinations and sub-combinations of all elements, features, and aspects discussed above. All such appropriate modifications and variations are intended to be included within the scope of the present disclosure, and all possible claims to individual aspects or combinations of elements or steps are intended to be supported by the present disclosure.

What is claimed is:

1. A non-transitory computer-readable storage medium storing instructions that, when executed by a processor, cause the processor to:
generate a plurality of augmented reality overlays to be displayed based on a received trigger image, the overlays including content; and
define a plurality of targeting groups, each targeting group being associated with a targeting campaign aimed at a classification of user comprising a subset of the plurality of augmented reality overlays.

2. The non-transitory computer-readable storage medium of claim 1, further storing instructions that, when executed by the processor, cause the processor to:
cause one of the campaigns to be displayed on a user computing device based on a received user property of the user computing device indicative of the targeting group of the one of the campaigns.

3. The non-transitory computer-readable storage medium of claim 2, wherein the received user property of the user computing device is a geographic region.

4. The non-transitory computer-readable storage medium of claim 2, wherein the received user property of the user computing device is user demographic information.

5. The non-transitory computer-readable storage medium of claim 1, further storing instructions that, when executed by the processor, cause the processor to:
preview one of the campaigns when one of the targeting groups is selected.

6. The non-transitory computer-readable storage medium of claim 1, further storing instructions that, when executed by the processor, cause the processor to:
alter at least one of the campaigns based at least in part on the preview.

7. A computing system comprising:
an overlay generation module to generate augmented reality overlays;
a targeting module to define a plurality of targeting groups, each targeting group being associated with a targeting campaign aimed at a classification of user, the targeting campaign comprising a subset of the plurality of augmented reality overlays; and
an overlay preview module to cause one of the targeting campaigns to be displayed on the computing system based on a selected targeting group.

8. The computing system of claim 7, further comprising:
an overlay display module to cause one of the subset of the plurality of augmented reality overlays to be displayed on a user computing device based on a received user property of the user computing device indicative of the targeting group of the one of the campaigns.

9. The computing system of claim 8, wherein causing the one of the subset of the plurality of augmented reality overlays to be displayed is responsive to receiving a trigger image from the user computing device.

10. The computing system of claim 8, wherein the received user property of the user computing device is a geographic region.

11. The computing system of claim 8, wherein the received user property of the user computing device is user demographic information.

12. The computing system of claim 7, further comprising:
an overlay alteration module to enable alteration of at least one of the augmented reality overlays.

13. A method comprising:
receiving, by a computing system, a trigger image and a user property indicative of a targeting campaign aimed at a classification of user from a user computing device; and
determining, by the computing system, which one of a plurality of targeting campaigns of augmented reality overlays corresponds to the user property.

14. The method of claim 13, further comprising:
causing, by the computing system, an overlay of the one of the targeting campaigns of augmented reality overlays corresponding to the user property to be displayed on the user computing device.

15. The method of claim 1, wherein an overlay of a default targeting campaign is caused to be displayed when no targeting campaign corresponds to one of the targeting campaigns.
